(19) United States
(12) Patent Application Publication
(10) Pub. No.: US 2021/0162327 A1
(43) Pub. Date: Jun. 3, 2021

(54) DIRECTIONAL AIRFLOW DEVICE AND AIR CLEANER WITH SAME

(71) Applicant: LG ELECTRONICS INC., Seoul (KR)

(72) Inventors: Tae Man YANG, Seoul (KR); Choon Myun CHUNG, Seoul (KR); Joon Min PARK, Seoul (KR)

(73) Assignee: LG ELECTRONICS INC.

(21) Appl. No.: 17/089,458

(22) Filed: Nov. 4, 2020

(30) Foreign Application Priority Data
Dec. 2, 2019 (KR) 10-2019-0158513

(51) Int. Cl. B01D 46/00; B01D 46/24

(52) U.S. Cl. CPC B01D 46/0049; B01D 2273/30; B01D 46/24

(57) ABSTRACT

Proposed are a directional airflow device and an air cleaner with the same. The directional airflow device includes: a cylindrical fan accommodating portion (140) including a fan assembly (150) that is configured to generate a flow of air; and a cylindrical guide accommodating portion (160) integrally formed on the fan accommodating portion (140), and including an airflow forming member (170) that is configured to discharge air suctioned by the fan assembly and guided to an airflow forming space, through a discharge port, wherein the airflow forming member is configured such that at least two helical bodies having different pitches are arranged in the airflow forming space along a circumferential direction of the guide accommodating portion, so that a part of the helical bodies forms a directional airflow having straightness, and a remaining part discharges air radially.

### CROSS REFERENCE TO RELATED APPLICATION

The present application claims priority to Korean Patent Application No. 10-2019-0158513, filed Dec. 2, 2019, the entire contents of which is incorporated herein for all purposes by this reference.

### BACKGROUND OF THE INVENTION

### Field of the Invention

The present disclosure relates generally to an air cleaner and, more particularly, to an air cleaner that discharges filtered air in all directions of 360 degrees.

### Description of the Related Art

In general, an air cleaner is configured to purify an indoor space such as a home or an office. According to the air cleaner in the related art, there is a problem in that the capacity thereof is limited, and thus purification of air in the entire indoor space is limited. Therefore, while air around the air cleaner is purified, air in a space far from the air cleaner is difficult to purify.

In order to solve this, efforts have been made to improve the performance of a fan provided in the air cleaner. However, noise generated from the fan increases as a blowing amount of the fan increases, resulting in a problem in that the reliability of a product is deteriorated.

Consequently, due to the limited capacity of the air cleaner, the air cleaner is required to be moved by a user in order to purify air in a desired space, which is inconvenient.

In an effort to solve this problem, a cylindrical air cleaner has been disclosed in Korean Patent Application Publication No. 10-2018-0000285 (Patent Document 1).

The air cleaner of Patent Document 1 is formed in a cylindrical shape to purify indoor air in all directions of 360 degrees. In detail, indoor air is suctioned through a first suction portion 102 and a second suction portion 202, and filtered air is discharged to a first discharge portion 105 and a second discharge portion 205 as a first blowing device 100 and a second blowing device 200 are driven.

The second blowing device 200 includes a flow conversion device 300 so that a directional airflow that rotates independently and causes filtered air to be discharged in a specific direction may be formed, thereby delivering air in a specific direction in which air pollution is severe.

Meanwhile, the first blowing device 100 discharges air in all directions of 360 degrees, but does not form a directional airflow having straightness in a specific direction. Therefore, there is a problem in that a space for installing a separate motor and fan for forming such a directional airflow is not secured.

The first blowing device 100 includes a first air guide device 170 for guiding a flow of air. The first air guide device 170 includes a plurality of guide ribs 175 arranged in a spaced apart relationship to guide filtered air upward. However, the guide ribs 175 also serve only to guide air upward, and thus do not form a directional airflow that delivers air in a specific direction.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent Application Publication No. 10-2018-0000285

### SUMMARY OF THE INVENTION

Accordingly, the present disclosure has been made keeping in mind the above problems occurring in the related art, and an objective of the present disclosure is to provide an air cleaner that forms a directional airflow without requiring the provision of a separate driving device, while maintaining a cylindrical shape.

In order to achieve the above objective, according to one aspect of the present disclosure, there is provided a directional airflow device, including: a cylindrical fan accommodating portion including a fan assembly that is configured to generate a flow of air; and a cylindrical guide accommodating portion integrally formed on the fan accommodating portion, and including an airflow forming member that is configured to discharge air suctioned by the fan assembly and guided to an airflow forming space, through a discharge port, wherein the airflow forming member may be configured such that at least two helical bodies having different pitches may be arranged in the airflow forming space along a circumferential direction of the guide accommodating portion, so that a part of the helical bodies may form a directional airflow having straightness, and a remaining part may discharge air radially.

The airflow forming space of the guide accommodating portion may be isolated from a central motor accommodating chamber by a partition wall.

Each of the helical bodies may have the same width as that of the airflow forming space.

The helical bodies may include: a first helical body extending in a strip shape along a circumferential direction of the airflow forming space, and formed in a helical shape to face the discharge port; and a second helical body extending from the same starting point as that of the first helical body and formed on an upper surface of the first helical body so as to be relatively steeper than the first helical body, the second helical body extending along the circumferential direction of the airflow forming space and being formed in a helical shape to be oriented toward the discharge port.

The air may flow along a lower end surface of the first helical body to form the directional airflow having straightness, and may flow along an upper end surface of the second helical body to be discharged in all directions through the discharge port.

The second helical body may be configured to compensate for a height difference caused by a step between the second helical body and the first helical body.

The first helical body may extend to have a central angle of 250 to 290 degrees with a center of the airflow forming space as an origin, and the second helical body may extend to have a central angle of 80 to 100 degrees with the center of the airflow forming space as the origin.

The first helical body may be configured to have a pitch of 110 to 120 mm, and the second helical body may be configured to have a pitch of 340 to 360 mm.

A rotary motor may be accommodated in the motor accommodating chamber, and the rotary motor may be configured to rotate a blowing fan of the fan assembly provided under the guide accommodating portion.

In the directional airflow device and the air cleaner with the same according to the present disclosure, the following effects may be obtained.

According to the present disclosure, since the air cleaner may include the directional airflow device that imparts directionality and straightness to filtered air without requiring the provision of a separate driving device, the air cleaner may discharge the filtered air in all directions of 360 degrees and purify indoor air in a specific area, while maintaining a cylindrical shape.

According to the present disclosure, since the first helical body of the directional airflow device may allow air to be discharged with directionality, designers and users may predict the direction in which air will be discharged. Therefore, it may be possible to deliberately set the direction so that a directional airflow may be discharged to an indoor area with high pollution, and thus, more effective indoor air purification may be possible.

According to the present disclosure, the second helical body of the directional airflow device may prevent air separated from the first helical body from stagnating in the airflow forming space and may guide the air to be discharged in all directions of 360 degrees. Therefore, the straightness of the directional airflow may be improved, and the air discharge amount in all directions of 360 degrees may be increased.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating an outer appearance of an air cleaner according to the present disclosure;

FIG. 2 is a perspective view illustrating an internal configuration of the air cleaner according to an embodiment of the present disclosure;

FIG. 3 is a sectional view of FIG. 1;

FIGS. 4A and 4B are respectively a transparent front view and a transparent perspective view illustrating a directional airflow device according to an embodiment of the present disclosure;

FIG. 5 is a top view illustrating the directional airflow device according to the embodiment of the present disclosure;

FIG. 6 is a transparent perspective view illustrating airflow inside the directional airflow device according to the embodiment of the present disclosure;

FIG. 7 is a top view illustrating airflow of the directional airflow device according to the embodiment of the present disclosure; and

FIG. 8 is a perspective view illustrating airflow from the exterior of the air cleaner illustrated in FIG. 3.

### DETAILED DESCRIPTION OF THE INVENTION

Hereinafter, embodiments of the present disclosure will be described in detail with reference to the illustrative drawings. Regarding the reference numerals assigned to the components in the drawings, it should be noted that the same reference numerals are used throughout the different drawings to designate the same or similar components. Also, in the description of embodiments, detailed descriptions of known functions or structures may make the gist of the present disclosure unclear, the detailed descriptions of the known functions or structures will be omitted.

Further, when describing the components of the present disclosure, terms such as first, second, A, B, (a), or (b) may be used. Since these terms are provided merely for the purpose of distinguishing the components from each other, they do not limit the nature, sequence, or order of the components. In a case where it is described that any component is “connected” or “coupled” to another component, it can be directly connected or coupled to the other component. However, it will be understood that another component may be “connected” or “coupled” between the components.

Exemplary embodiments of a directional airflow device and an air cleaner with the same according to the present disclosure will be described with reference to the accompanying drawings.

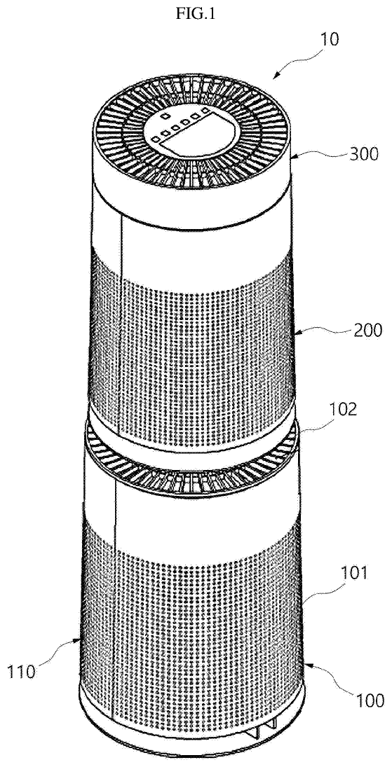

Referring to FIG. 1, the air cleaner 10 according to an embodiment of the present disclosure may include blowing devices 100 and 200 for generating airflow and a flow conversion device 300 for converting a discharge direction of the airflow generated by the blowing devices 100 and 200, and may have a cylindrical appearance.

The blowing devices 100 and 200 may include a first blowing device 100 and a second blowing device 200 for generating airflow.

The flow conversion device 300 may be provided on the second blowing device 200, and the first blowing device 100 may be provided under the second blowing device 200, so that the first and second blowing devices 100 and 200 and the flow conversion device 300 may be arranged in a vertical direction. The first and second blowing devices 100 and 200 may respectively suction in air in an indoor space, and then perform filtering to filter out pollutants, and finally discharge air resulting from the filtering (hereinafter, filtered air).

The first blowing device 100 and the second blowing device 200 may have a substantially cylindrical shape similar to that of the air cleaner 10, which may make it possible to suction in indoor air and discharge filtered air, in all directions of 360 degrees. Here, all directions refer to directions radial with respect to the air cleaner 10.

Meanwhile, in the present embodiment, the second blowing device 200 may include the flow conversion device 300 so that the second blowing device 200 may blow filtered air to a specific area where indoor air is contaminated. However, the first blowing device 100 may include no flow conversion device 300. However, the first blowing device 100 may include an airflow forming member 170 which will be described below, so that filter air is blown to a specific area. Therefore, in the present disclosure, main parts are provided in the first blowing device 100, and thus, detailed descriptions of other structures, i.e., the second blowing device 200 and the flow conversion device 300, will be omitted.

The first blowing device 100 may include a casing 101 and a discharge grill 102 that define an outer appearance thereof. The casing 101 may be formed in a substantially cylindrical shape. In detail, the shape thereof may be a truncated cone shape close to a cylindrical shape. The casing 101 may be detachably coupled to the first blowing device 100, so that when maintenance work such as repair or filter replacement is required, the maintenance work may be performed by separating the casing 101.

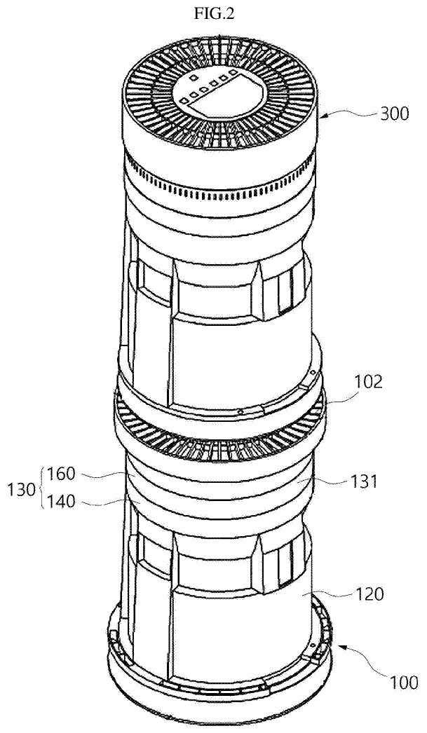

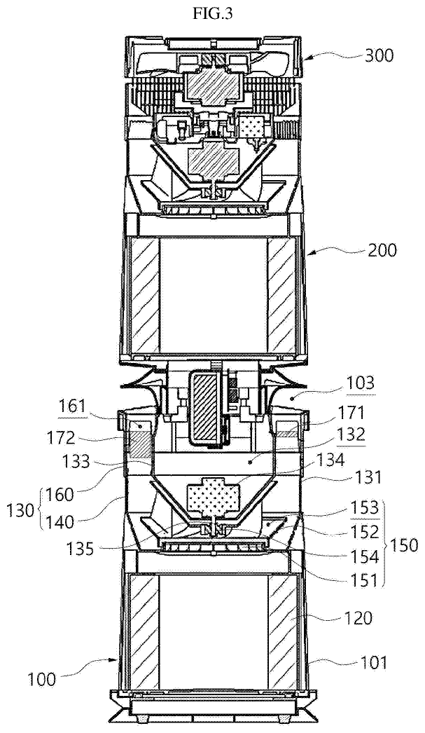

The discharge grill 102 may be attached to an upper portion of the casing 101. The discharge grill 102 may have a mesh shape and may close an open portion of the casing 101. Since the discharge grill 102 may have a mesh shape, as illustrated in FIG. 2, filtered air may exit through a discharge port 103 and spread to the indoor space.

A suction grill 110 may be installed at a lower portion of the first blowing device 100. The suction grill 110 may be formed on an outer surface of the casing 101 or installed at a lower end of the first blowing device 100 to suction in air present close to a bottom surface thereof. The suction grill 110 may serve as a passage through which indoor air is suctioned and introduced to an inside of the air cleaner 10, and the shape thereof is not particularly limited. However, the suction grill 110 may be formed evenly along a circumferential direction of the first blowing device 100 to suction in indoor air in all directions of 360 degrees. In addition, the suction grill 110 is preferably formed close to a filter 120 of the first blowing device 100.

FIG. 2 is a perspective view illustrating the appearance after separating the casing 101 of the air cleaner 10 according to the present embodiment. When the casing 101 of the first blowing device 100 is removed, there is a configuration including the filter 120 and a directional airflow device 130 installed inside of the casing 101.

The filter 120 may be disposed at a position corresponding to the suction grill 110, and the directional airflow device 130 may be installed on the filter 120. The filter 120 may remove pollutants (e.g., dust, odor, etc.) present in indoor air suctioned through the suction grill 110 and convert the same into filtered air. The filter 120 may be disposed in a circumferential direction to conform to the shape of the air cleaner 10. Therefore, the filter 120 may remove all pollutants of indoor air suctioned in all directions through the suction grill 110. The filter 120 may be maintained in the arrangement in the circumferential direction through a separate support device (not illustrated).

The directional airflow device 130 may be installed on the filter 120 to directly generate airflow. The directional airflow device 130 may include a housing 131 defining an outer appearance thereof, and a motor accommodating chamber 132 formed therein.

The housing 131 may be located on the filter 120 and may have a substantially cylindrical shape. A partition wall 133 may be formed in the housing 131 in a circumferential direction at a position spaced inward apart from an outer surface of the housing 131 by a predetermined distance.

By the partition wall 133, the motor accommodating chamber 132 may be formed inside of the housing 131. The motor accommodating chamber 132 may be gradually reduced in diameter toward the filter 120 and then completely sealed, and the partition wall 133 may also be formed to conform to the shape of the motor accommodating chamber 132.

A rotary motor 134 may be installed on the bottom of the motor accommodating chamber 132. The rotary motor 134 may include a rotary shaft 135. The rotary shaft 135 may pass through the bottom of the motor accommodating chamber 132 and may be coupled to a fan assembly 150 which will be described later. When the rotary motor 134 generates torque, the torque may be transmitted to the fan assembly 150 through the rotary shaft 135.

The housing 131 of the directional airflow device 130 may be divided into a fan accommodating portion 140 and a guide accommodating portion 160. The fan assembly 150 may be installed in the fan accommodating portion 140. The fan assembly 150 may be coupled to the rotary motor 134 to directly generate a flow of air, and to deliver the air to the guide accommodating portion 160.

The fan assembly 150 may include a blowing fan 151 installed toward the filter 120. When the blowing fan 151 rotates, indoor air may be introduced into the suction grill 110 and then may pass through the filter 120, thereby becoming filtered air from which pollutants are removed.

The blowing fan 151 may be formed on a fan hub 152. The fan hub 152 may define an outer appearance of the fan assembly 150, and may include a blowing path 153 formed inside thereof to guide filtered air having passed through the filter 120 to the guide accommodating portion 160 through the blowing path 153. The fan hub 152 may be formed to conform to the shape of the motor accommodating chamber 132 of which the cross-sectional area may be gradually reduced downward. That is, the fan hub 152 may be formed in parallel with an outer surface thereof spaced apart from the partition wall 133 by a predetermined distance. Therefore, the blowing path 153 may be formed to be inclined upward to face the guide accommodating portion 160.

A shaft coupling portion 154 may be formed in a center of the fan hub 152. The rotary shaft 135 protruding through the partition wall 133 in the motor accommodating chamber 132 may be coupled to the shaft coupling portion 154. More precisely, the blowing fan 151 formed on the fan hub 152, and the rotary shaft 135 may be rotatably coupled to each other through the shaft coupling portion 154. Therefore, the fan hub 152 may not be rotated by the torque of the rotary motor 134, but the blowing fan 151 formed on the fan hub 152 may rotate to generate a flow of air.

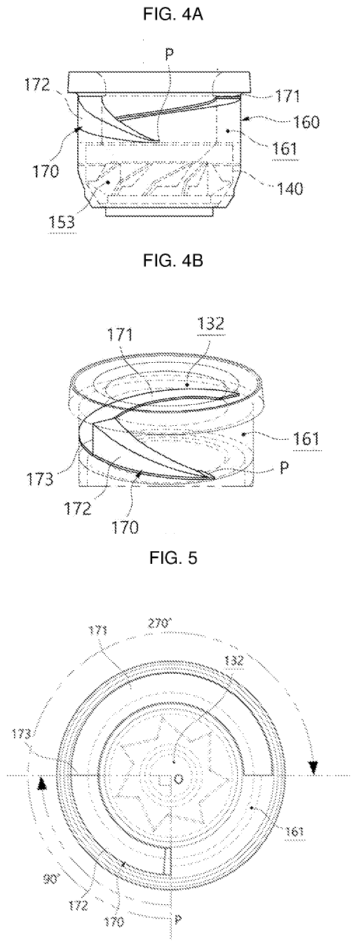

Referring to FIGS. 4A, 4B, and 5, the guide accommodating portion 160 may include an annular airflow forming space 161 extending in the longitudinal direction of the housing 131. The airflow forming space 161 and the motor accommodating chamber 132 may be isolated from each other by the partition wall 133, and the airflow forming space 161 may be formed at a position surrounding the motor accommodating chamber 132. The guide accommodating portion 160 may discharge filtered air delivered from the fan assembly 150 of the fan accommodating portion 140 to the indoor space.

An airflow forming member 170 may be formed in the guide accommodating portion 160. When the airflow forming member 170 delivers filtered air delivered to the guide accommodating portion 160 through the blowing path 153 to the indoor space, the airflow forming member 170 may guide the filtered air to be biased and discharged in one direction. The airflow forming member 170 may allow the filtered air not to simply pass through the guide accommodating portion 160 and be discharged above the discharge port 103, but to flow along a flow path conforming to the shape of the airflow forming member 170, so that the flow rate of the filtered air may be increased and a biased flow of filtered air may occur. That is, the airflow forming member 170 may discharge the filtered air in all directions of 360 degrees through the discharge port 103, while simultaneously forming and discharging a directional airflow biased toward one side.

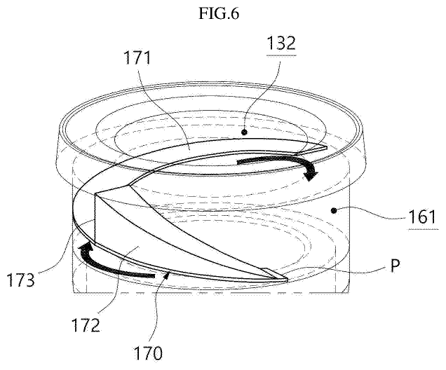

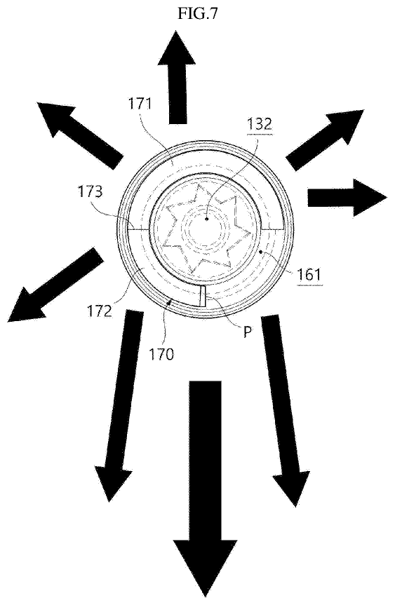

Referring to FIGS. 5 and 6, the airflow forming member 170 may include a first helical body 171 and a second helical body 172, and may be formed in the airflow forming space 161.

The first helical body 171 may be formed in a helical shape to be oriented toward the discharge port 103 along the longitudinal direction of the directional airflow device 130 in the airflow forming space 161. The first helical body 171 may be configured to have the same width as that of the airflow forming space 161 so that filtered air may flow along a lower end surface of the first helical body 171.

In detail, the first helical body 171 may have a strip shape. The first helical body 171 may be formed along a circumferential direction of the airflow forming space 161. The length of the first helical body 171 may be defined by drawing an arc having a central angle of 250 to 290 degrees with the center of the airflow forming space 161 as an origin, and preferably drawing an arc having a central angle of 260 to 280 degrees. In addition, the first helical body 171 may be configured to have a pitch of 110 to 120 mm. The size of the width of the first helical body 171 may be determined according to that of the airflow forming space 161. When the first helical body 171 does not have a sufficient length, a biased flow of filtered air may be reduced with the result that a directional airflow having a sufficient intensity may not be formed. In addition, when the first helical body 171 is formed excessively long at an angle of equal to or greater than 360 degrees, airflow that may spread in all directions of 360 degrees other than the directional airflow may not be formed.

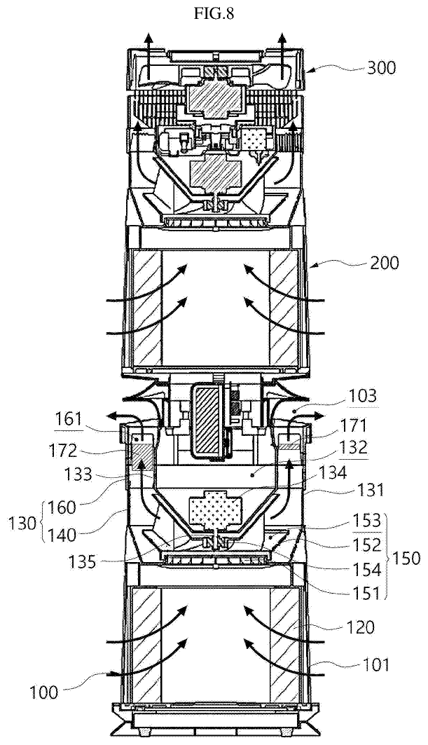

Referring to FIG. 7, the direction in which a tip end of the first helical body 171 is oriented is the same as the direction in which the directional airflow is discharged to the indoor space. The filter air may flow along the lower end surface of the first helical body 171 as the flow rate thereof gradually increases, and may be discharged in the direction in which the tip end of the first helical body 171 is oriented. This may be the same action as the action that an object rotating around the origin flies in a direction of a point of contact of a circle centered on the origin by centrifugal force generated when coupling force with the origin is released. Since the filtered air is a fluid, the filtered air may not advance only in the direction in which the tip end of the first helical body 171 is oriented. However, by creating a biased blow of filtered air in a specific direction as described above, a directional airflow having straightness may be generated.

Referring to FIGS. 5 and 6, the second helical body 172 may be formed on an upper surface of the first helical body 171. As in the case of the first helical body 171, the second helical body 172 may be formed in a helical shape to be oriented toward the discharge port 103 along the longitudinal direction of the directional airflow device 130 in the airflow forming space 161. The second helical body 172 may configured to have the same width as that of the airflow forming space 161, so that filtered air that has passed through the first helical body 171 may flow along an upper end surface of the second helical body 172.

In detail, the second helical body 172 may have the same starting point P as that of the first helical body 171, and may be formed along the circumferential direction of the airflow forming space 161. The length of the second helical body 172 may be defined by drawing an arc having a central angle of 80 to 100 degrees with the center of the airflow forming space 161 as an origin, and preferably drawing an arc having a central angle of 90 degrees. In addition, the second helical body 172 may have a pitch of 340 to 360 mm, so that the second helical body 172 may be formed relatively steeper than the first helical body 171. Therefore, a step 173 may be formed between the second helical body 172 and the first helical body 171, resulting in a height difference. The second helical body 172 may have a strip shape similar to that of the first helical body 171, but may be formed to compensate for a gap caused by the step 173, the gap corresponding to the height difference. The size of the width of the second helical body 172 may be determined according to that of the airflow forming space 161.

Since the second helical body 172 may be formed steeper than the first helical body 171, the second helical body 172 may serve to block a part of the flow path of filtered air, thereby preventing spreading of the filtered air discharged in the direction of the tip end of the first helical body 171 to thereby enhance the directional airflow. That is, the straightness of the directional airflow may be improved. At the same time, since the second helical body 172 may have a helical shape with an inclination, the second helical body 172 may guide air that has not yet exited through the discharge port 103 to continue to flow along the upper surface of the second helical body 172 without stagnating in the airflow forming space 161. The air flowing along the upper surface of the second helical body 172 may be further reduced in flow velocity by the step 173 and may be discharged in all directions of 360 degrees.

Next, a process in which indoor air is suctioned and discharged by the first blowing device 100 will be described.

Referring to FIG. 8, when the rotary motor 134 provided in the directional airflow device 130 rotates, torque may be transmitted to the blowing fan 151 by the rotary shaft 135 so that the blowing fan 151 may be rotated in conjunction with the rotation of the rotary motor 134. As the blowing fan 151 rotates, contaminated indoor air outside the air cleaner 10 may be suctioned into the air cleaner 10 through the suction grill 110 of the casing 101.

The indoor air suctioned into the air cleaner 10 may pass through the filter 120, thereby becoming filtered air from which pollutants such as odor molecules and dust are removed, and then the filtered air may move from the inside of the filter toward the fan assembly 150.

The filtered air that has reached the fan assembly 150 may pass through the blowing path 153 and reach the airflow forming space 161 of the directional airflow device 130. The filtered air may move toward the discharge port 103 while helically rotating along the lower end surface of the first helical body 171. Due to a relatively narrow space compared to the blowing path 153 provided in the fan accommodating portion 140 and a shape in which the flow path is partially blocked by the first helical body 171, the flow velocity of the filtered air may be increased.

The filtered air which has reached the tip end of the first helical body 171 while rotating helically may form a directional airflow by centrifugal force and inertia in the direction in which the tip end of the first helical body 171 is oriented and may be discharged through the discharge port 103. The direction in which the directional airflow is formed may be controlled according to the shape of the first helical body 171, so that the filtered air may be discharged in a direction desired by a user. At this time, the second helical body 172 may prevent the filtered air having passed through the first helical body 171 from spreading, thereby improving the straightness of the directional airflow.

Meanwhile, filtered air that has not yet been discharged by the directional airflow may continue to flow toward the discharge port 103 along the upper surface of the second helical body 172 having a helical shape with an inclination. Therefore, the filtered air flowing along the upper surface of the second helical body 172 may not stagnate in the airflow forming space 161, but may be discharged through the discharge port 103 in all directions of 360 degrees.

In the present embodiment described above, the airflow forming member 170 may be provided only in the first blowing device 100. However, the present disclosure is not limited thereto, and it will be understood that the airflow forming member 170 may be installed in the second blowing device 200.

Hereinabove, even though all of the components of an embodiment of the present disclosure are coupled into one body or operate in a combined state, the present disclosure is not limited to this embodiment. That is, all of the components may operate in one or more selective combinations within the range of the purpose of the present disclosure. It will be further understood that the terms “comprise”, “include”, “have”, etc. when used in this specification, specify one or more corresponding components may exist and, unless specifically described to the contrary, do not exclude but may include additional components. Unless otherwise defined, all terms including technical and scientific terms used herein have the same meaning as commonly understood by one of ordinary skill in the art to which the present disclosure belongs. The terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the exemplary embodiments of the present disclosure have been described for illustrative purposes, those skilled in the art will appreciate that various modifications, additions and substitutions are possible, without departing from the scope and spirit of the present disclosure. Therefore, the embodiments disclosed in the present disclosure are not to limit but are merely to describe the technical spirit of the present disclosure. Further, the scope of the technical spirit of the present disclosure is not limited by the embodiments. The scope of the present disclosure should be determined on the basis of the descriptions in the appended claims, and all equivalents thereof should belong to the scope of the present disclosure.

What is claimed is:

1. A directional airflow device, comprising:
a cylindrical fan accommodating portion including a fan assembly that is configured to generate a flow of air; and
a cylindrical guide accommodating portion integrally formed on the fan accommodating portion, and including an airflow forming member that is configured to discharge air suctioned by the fan assembly and guided to an airflow forming space, through a discharge port,
wherein the airflow forming member is configured such that at least two helical bodies having different pitches are arranged in the airflow forming space along a circumferential direction of the guide accommodating portion, so that a part of the helical bodies forms a directional airflow having straightness, and a remaining part discharges air radially.

2. The directional airflow device of claim 1, wherein the airflow forming space of the guide accommodating portion is isolated from a central motor accommodating chamber by a partition wall.

3. The directional airflow device of claim 2, wherein each of the helical bodies has the same width as that of the airflow forming space.

4. The directional airflow device of claim 3, wherein the helical bodies comprise:
a first helical body extending in a strip shape along a circumferential direction of the airflow forming space, and formed in a helical shape to face the discharge port; and
a second helical body extending from the same starting point as that of the first helical body and formed on an upper surface of the first helical body so as to be relatively steeper than the first helical body, the second helical body extending along the circumferential direction of the airflow forming space and being formed in a helical shape to be oriented toward the discharge port.

5. The directional airflow device of claim 4, wherein the air flows along a lower end surface of the first helical body to form the directional airflow having straightness, and flows along an upper end surface of the second helical body to be discharged in all directions through the discharge port.

6. The directional airflow device of claim 5, wherein the second helical body is configured to compensate for a height difference caused by a step between the second helical body and the first helical body.

7. The directional airflow device of claim 6, wherein the first helical body extends to have a central angle of 250 to 290 degrees with a center of the airflow forming space as an origin, and
the second helical body extends to have a central angle of 80 to 100 degrees with the center of the airflow forming space as the origin.

8. The directional airflow device of claim 7, wherein the first helical body is configured to have a pitch of 110 to 120 mm, and
the second helical body is configured to have a pitch of 340 to 360 mm.

9. The directional airflow device of claim 2, wherein a rotary motor is accommodated in the motor accommodating chamber, and the rotary motor is configured to rotate a blowing fan of the fan assembly provided under the guide accommodating portion.

10. An air cleaner with the directional airflow device of claim 1.
